(19) United States
(12) Patent Application Publication
(10) Pub. No.: US 2015/0284017 A1
(43) Pub. Date: Oct. 8, 2015

(54) Wheelbarrow Attachment

(71) Applicant: Gary Nilsen, Redmond, WA (US)

(72) Inventor: Gary Nilsen, Redmond, WA (US)

(21) Appl. No.: 14/246,465

(22) Filed: Apr. 7, 2014

(51) Int. Cl. B62B 1/20; B62B 1/26

(52) U.S. Cl. CPC B62B 1/204; B62B 1/262

(57) ABSTRACT

The instant application discloses, among other things, a wheelbarrow attachment. In one embodiment, a wheelbarrow attachment may attach to any part of a wheelbarrow. A wheelbarrow attachment may include a plurality of holders designed to secure various items, such as gardening, construction, or farming tools.

### FIELD

This disclosure relates generally to a Wheelbarrow Attachment.

### BACKGROUND

Gardeners, construction workers, farmers, and other wheelbarrow users must often transport various items in addition to the load contained in their wheelbarrow bin. These items may include tools such as shovels, rakes, and picks, for example. The size, weight, and shape of these items may preclude them from fitting securely inside of the bin. As a result, the items may fall, cause the wheelbarrow to tip, damage nearby property, or injure people or livestock.

### SUMMARY

The following presents a simplified summary of the disclosure to provide a basic understanding to the reader. This summary is not an extensive overview of the disclosure, nor does it identify key or critical elements of the claimed subject matter, or define its scope. Its sole purpose is to present some concepts disclosed in a simplified form as a precursor to the more detailed description that is later presented.

The instant application discloses, among other things, a Wheelbarrow Attachment. In one embodiment, a Wheelbarrow Attachment may comprise a rack which may attach to the side of a wheelbarrow bin. Wheelbarrow Attachment may include a plurality of holders designed to secure various items, for example, gardening tools. In this embodiment, the holders may be arranged so as to allow elongated handles of tools such as shovels, rakes, and picks, for instance, to rest horizontally along the side of the bin. Wheelbarrow Attachment may also include a handle which a user may pull upward to disconnect the rack from the wheelbarrow bin and to carry the items away.

In another embodiment, the Wheelbarrow Attachment may include holders comprised of hooks, belts, buckles, hook and loop fasteners such as Velcro, adhesives, magnets, or any other holding means.

A person skilled in the art will understand that a Wheelbarrow Attachment may be made into various shapes, sizes, and colors. It may also be made of various materials, such as wood, plastic, rubber, metal, or carbon fiber, for example.

Many of the attendant features may be more readily appreciated as they become better understood by reference to the following detailed description considered in connection with the attached drawings.

### BRIEF DESCRIPTION OF THE DRAWINGS

FIG. 1 is a front perspective view of a Wheelbarrow Attachment, according to one embodiment.

FIG. 2 is a front view of a Wheelbarrow Attachment connected to the outer side of wheelbarrow bin, according to the first embodiment.

FIG. 3 is a front perspective view of a Wheelbarrow

Attachment according to another embodiment.

### DETAILED DESCRIPTION

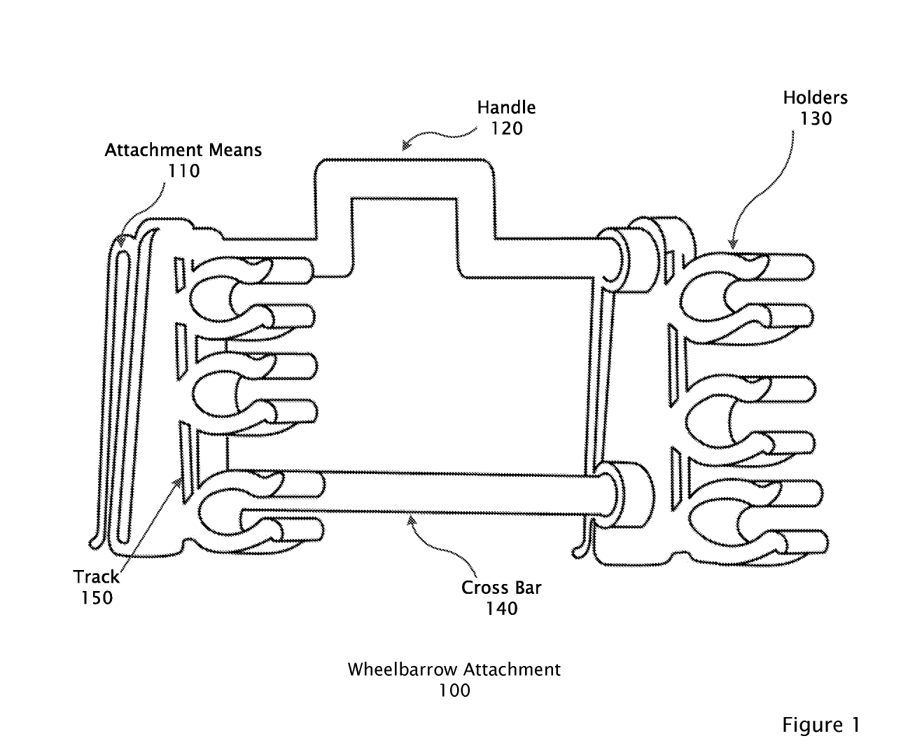

FIG. 1 is a front perspective view of a Wheelbarrow Attachment, according to one embodiment. In this example, Wheelbarrow Attachment 100 may be attached to any part of a wheelbarrow, for instance, to the outer side of a wheelbarrow bin. Wheelbarrow Attachment 100 may be made into various shapes, sizes and colors, and may be made of various materials, such as wood, plastic, rubber, metal, or carbon fiber, for example.

Wheelbarrow Attachment 100 may be secured to the wheelbarrow by Attachment Means 110, which may comprise a clip that uses tension to hold Wheelbarrow Attachment 100 securely in place. Attachment Means 110 may also comprise a hook, adhesive, magnet, or any other attachment means. Wheelbarrow Attachment may include a Handle 120 at the top portion of the rack, for example. A user may grasp and lift Handle 120 in order to disconnect Wheelbarrow Attachment 100 from the wheelbarrow. Handle 120 may have a grip designed to enhance traction or comfort, for example. A grip on Handle 120 may be made of one of a variety of materials, including, for example rubber, foam, silicone, gel, plastic, leather, or a combination of two or more materials.

Wheelbarrow Attachment 100 may include a plurality of Holders 130 designed to hold items such as gardening, farming, or construction tools, for example. Holders 130 may be comprised of U-shaped cavities that are tapered on its outer ends to help keep items placed inside Holders 130 securely in place. Holders 130 may be arranged so as to allow elongated handles of tools such as shovels, rakes, and picks, for instance, to rest horizontally along the side of the wheelbarrow bin. Holders 130 may also comprise any other means of securing objects, including but not limited to any type or combination of clips, spring-loaded clips, hook and loop fasteners such as Velcro, adhesives, magnets, S-hooks, snap hooks, bolt plates, anchor plates, j-hooks, flat hooks, ratchet fasteners, over-center fasteners, slide buckles, snap buckles, and containers, for example. Holders 130 may adjust position by sliding in Track 150, and may be held in place by friction, a tightening fastener, or other means.

Wheelbarrow Attachment 100 may also include one or a plurality of Cross Bar 140 in order to support or distribute the weight of items placed on the rack.

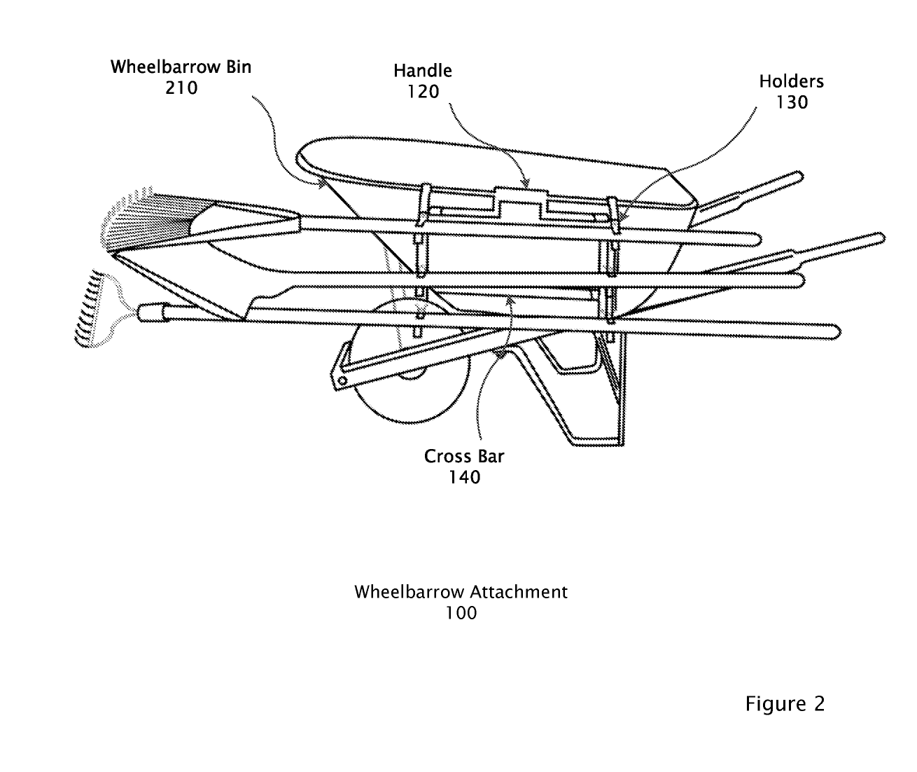

FIG. 2 is a front view of a Wheelbarrow Attachment 100 connected to the outer side of wheelbarrow bin, according to one embodiment. In this example, Wheelbarrow Attachment 100 may be secured to the outer side of Wheelbarrow Bin 210. Wheelbarrow Attachment 100 may also attach to any other part of a wheelbarrow, including the outer side of the back of Wheelbarrow Bin 210, or the outer side of the front of Wheelbarrow Bin 210, for example.

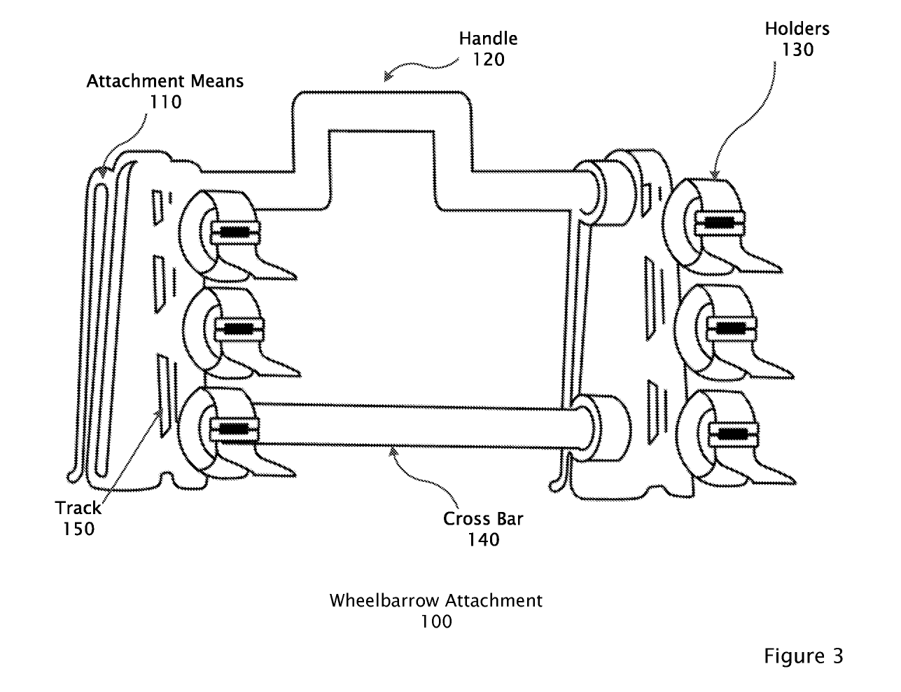

FIG. 3 is a front perspective view of a Wheelbarrow

Attachment according to another embodiment. In this example, Wheelbarrow Attachment 300 may comprise a rack with an Attachment Means 310 that comprises a clip. It may also include a Handle 320 at the top portion of the rack, which a user may pull upward to remove Wheelbarrow Attachment 300 from Wheelbarrow Bin 210, and a Cross Bar 340 to support and distribute weight on the rack. In this embodiment, Holders 330 may be made of adjustable straps which may be made in any colors, shapes, sizes, and textures, and of any material such as nylon, polypropylene, polyester, webbing, mesh, cotton, spandex, rubber, silicone, plastic, rope, or cable, for example. Holders 330 may also be comprised of any other holding means including, but not limited to clips, spring-loaded clips, hook and loop fasteners such as Velcro, adhesives, magnets, S-hooks, snap hooks, bolt plates, anchor plates, j-hooks, flat hooks, ratchet fasteners, over-center fasteners, slide buckles, snap buckles, and containers, for example.

1. A wheelbarrow attachment, comprising:
a plurality of tracks;
a plurality of holders, each coupled to at least of the tracks;
a handle coupled to each of the tracks;
an attachment means coupled to at least one of the tracks, configured to secure the wheelbarrow attachment to a wheelbarrow.

2. The wheelbarrow of claim 1, wherein the wheelbarrow attachment is composed of one or more materials from the list containing wood, plastic, rubber, metal or carbon fiber.

3. The wheelbarrow attachment of claim 1, wherein the plurality of holders comprises U-shared cavities.

4. The wheelbarrow attachment of claim 1 wherein the plurality of holders comprise adjustable straps.

5. The wheelbarrow attachment of claim 1, wherein the plurality of holders comprise any objects from the list containing clips, hook and loop fasteners, adhesives, magnets, S-hooks, snap hooks, bolt plates, anchor plates, i-hooks, flat hooks, ratchet fasteners, over-center fasteners, slide buckles, snap buckles, and containers.

6. The wheelbarrow attachment of claim 1, wherein the handle includes a grip.

7. The wheelbarrow attachment of claim 1, wherein the handle includes a cushioned grip.

8. The wheelbarrow attachment of claim 1, wherein the attachment means for securing the rack to a wheelbarrow is comprised of any object from the list containing clips, adhesives, and magnets.
